(19) United States
(12) Patent Application Publication
(10) Pub. No.: US 2007/0172627 A1
(43) Pub. Date: Jul. 26, 2007

(54) Optical recording medium and method of manufacturing the same

(75) Inventors: Noriko Yamashita, Odawara (JP); Hiroaki Takano, Odawara (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/656,526

(22) Filed: Jan. 23, 2007

(30) Foreign Application Priority Data
Jan. 23, 2006 (JP) 2006-014236

(51) Int. Cl. B32B 3/02

(52) U.S. Cl. 428/64.4

(57) ABSTRACT

An optical recording medium records data in three dimensions by recording a plurality of pieces of data in an area extending in a thickness direction of a recording layer thereof, and keeps a bit error rate low, that is, reduces noise, even when the recording layer is made thicker. The recording layer has a thickness of 200 μm or more; contains at least one kind of a dye; and records data in three dimensions. An absorbance of the recording layer is 0.030 or less before data is recorded, at a wavelength longer than a wavelength of the recording light, at which the dye does not absorb light.

### CROSS REFERENCE TO RELATED APPLICATIONS

This application claims the benefit of Japanese Patent Application No. 2006-014236 filed on Jan. 23, 2006, the disclosure of which is incorporated herein by reference.

### BACKGROUND OF THE INVENTION

1. Field of the Invention

The present invention relates to an optical recording medium having a recording layer for recording data in three dimensions, and a method of manufacturing the same.

2. Description of the Related Art

A high capacity optical recording medium which has been currently used or studied includes a digital versatile disc (DVD), a Blu-ray disc, and a high definition DVD (HD DVD). Capacity of these media is, however, considered to be about 100 GB at a maximum. A further high capacity optical recording medium having more than 100 GB capacity has been studied such as a holographic memory and a multilayered optical memory which records data in three dimensions (volume-records).

The optical recording medium which volume-records data, such as a holographic memory and a multilayered optical memory, records data not only in an in-plane direction of a recording layer thereof but also in three dimensions of the same, which enables an increase in its capacity. A holographic memory can multiple-records data in the same portion on the same plane repeatedly. In a multi-layered optical memory, a bit is formed for recording on each of the multi-layered recording layers in the same portion on the same plane.

In an optical recording medium capable of volume-recording data, as a recording layer thereof becomes thicker, a distance that an incident light to the recording layer travels therein becomes longer, so that the incident light may be scattered owing to nonuniformity or the like in a material for the recording layer. To reduce the scattering is one of the problems in the holographic memory (see, for example, The 6th Seminar of the Research Group on Lightwave Synthesis, Preliminary bulletin, P-22 (2003)). However, it has not yet been known the scattering in which portion affects the S/N ratio and a bit error rate (BER).

It is important for an optical recording medium capable of volume-recording data to reduce a bit error rate of a transmission image in an unrecorded medium, namely, to reduce noise. It has been found that the bit error rate of a transmission image in an unrecorded medium correlates with the scattering in the medium, that is, an increase in scattering in the medium increases the bit error rate of a transmission image in the medium.

Therefore, the present invention provides an optical recording medium capable of recording data in three dimensions, and of keeping a bit error rate low, even when a recording layer thereof becomes thicker.

The present invention also provides a manufacturing method of the optical recording medium capable of recording data in three dimensions, and of keeping a bit error rate low, even when the recording layer becomes thicker.

### SUMMARY OF THE INVENTION

Preferably, the optical recording medium according to the present invention includes a recording layer having a thickness of 200 μm or more; containing at least one kind of a dye; and is capable of recording data in three dimensions. The optical recording medium may be characterized in that an absorbance of the recording layer is 0.030 or less before the data is recorded at a light wavelength longer than a wavelength of the recording light, at which the dye does not absorb light. Because the absorbance is measured at a wavelength at which the dye does not absorb light, the measured absorbance at the wavelength is not caused by absorption of light but scattering of the same. Additionally, an optical recording medium having a low bit error rate can be obtained, when the absorbance of the recording layer is 0.030 or less, because the absorbance is correlated with a bit error rate of a transmission image in an unrecorded medium.

Preferably, the method of manufacturing an optical recording medium according to the present invention includes the steps of: preparing a solution in which materials forming a recording layer thereof for recording data in three dimensions are dissolved; filtering the solution; drying the filtered solution; crushing the dried and filtered substance; and solidifying the crushed substance to form a recording layer having a thickness of 200 μm or more.

Other features and advantages of the present invention will become more apparent from the following detailed description of the invention, when taken in conjunction with the accompanying exemplary drawings.

### BRIEF DESCRIPTION OF THE DRAWINGS

FIG. 1 is a graphical drawing illustrating light absorbance spectrums of a recording layer of an optical recording medium according to an embodiment of the present invention.

### DETAILED DESCRIPTION OF THE EXEMPLARY EMBODIMENT

Next is described an embodiment of the present invention with reference to the related drawings. In the embodiment, an optical recording medium capable of volume-recording data in a thickness direction of a recording layer thereof is described. More specifically, a holographic memory capable of recording light information using holography (interference) is described. Further, the present invention can be applied to a multilayer optical memory.

A holographic memory according to the embodiment of the present invention has a recording layer therein. The recording layer may be provided with a light transmission substrate above and below the recording layer according to the necessity.

As is well known, when a reference light and a recording light are irradiated on the recording layer, light information as data is recorded therein as an interference pattern. If a number of different interference patterns are formed in the same portion (multiple-recorded) therein, the holographic memory can have a higher capacity. A multiple-recording mode which can be used herein includes the shift multiplex mode, the angle multiplex mode, the wavelength multiplex mode, the phase encoding multiplex mode, the polytopic multiplex mode, and a combination thereof. For example, if the angle multiplex mode is used, an incident angle of the reference light is changed for each recording light of a plurality of pieces of light information to be multiple-recorded. More specifically, irradiation of a recording light and of a reference light set at a predetermined incident angle to a portion to be recorded on a recording layer forms an interference pattern in the recording layer.

When an interference pattern is recorded in the recording layer, in the recording layer, materials in a boundary between a bright area and a dark area of the interference pattern, causing a difference in refractive index or transmission therein, which is the recording of data. Materials for a recording layer under study include a photopolymer material, a refractive index modulation dye type material, silver halide, bichromated gelatin, a photorefractive material, and a photochromic material.

The photopolymer material is under development as a promising material, because it exhibits a high diffraction efficiency, a low noise operation, and an excellent storage stability, if it is completely fixed in the recording layer after recording. A typical photopolymer material contains a binder, a polymerizable monomer, a sensitizing dye, and a polymerization initiator.

The refractive index of the binder and that of the polymerizable monomer to be used herein is different from each other. When data is recorded on the recording layer, a bright area and a dark area of an interference pattern are formed therein. In the bright area, a sensitizing dye is excited to emit electrons. The emitted electrons travel to the polymerization initiator, which thereby generates radicals or acids. The generated radicals or acids travel to monomers, initiating polymerization of the monomers. As a result, monomers even in the dark area adjoining the bright area gather in the bright area to be polymerized therein, making the bright area rich in monomers. In the meantime, the dark area becomes rich in the binders as the monomers leave therefrom. Thus the difference in the refractive index between the monomer-rich area and the binder-rich area enables a recording of such an interference pattern.

For example, if the angle multiplex mode is used, an incident angle of a reference light to be irradiated is changed. Such a reference light interferes with a recording light having other optical information forms a different interference pattern in the same portion as that in which data has already been recorded. This enables overlapped recordings of other optical information. Similarly, multiple-recording is performed to record a plurality of pieces of light information in one recording portion in the same recording layer.

Once the multi-recording of predetermined optical information in one record portion is finished, the reference light moves to another recording portion in the same recording layer. Another recording portion may be or may not be overlapped with the above-mentioned record portion. Then a newly aligned recording light and the reference light again multiple-record a plurality of pieces of light information.

Once the recording of predetermined light information in the recording layer is finished, polymerizable monomers not used for the recording of the light information in the recording layer are fixed by being exposed using a laser or a white light source or by heat treatment.

A hologram as light information recorded in the recording layer is, as is known, read out as a diffracted light generated by irradiation of a reproducing light in the same recording portion. For example, in a medium in which data is recorded with the angle multiplex mode, each of pieces of light information multiple-recorded in each recording portion can be read out by irradiating the reproducing light set at an incident angle of the reference light when each piece of light information has been recorded.

The recording layer is capable of recording the light information when light is irradiated thereto, and has a thickness of 200 μm or more, preferably 0.2 to 2.5 mm, and, more preferably 0.5 to 2.5 mm. If the recording layer has a thickness of 200 μm or more, the number of times of multiple-recordings to be performed by the recording layer can satisfy a level required when the recording layer is used for a commercially-available holographic memory. Meanwhile, if the recording layer has a thickness of 2.5 mm or less, fewer materials for the recording layer is necessary to thereby reduce a cost in manufacturing the holographic memory on a commercial basis.

The polymerizable monomer used herein includes, but not limited to, as long as having a polymerizable group, a radical polymerizable monomer, a cation polymerizable monomer, and a combination thereof. More specifically, the polymerizable monomer includes a compound containing a polymerizable group such as an epoxy group and an ethylene unsaturated group. The polymerizable monomer may contain any one or more of those polymerizable groups in a molecule thereof. The polymerizable monomer containing two or more of those polymerizable groups in a molecule thereof may contain the same or different polymerizable groups.

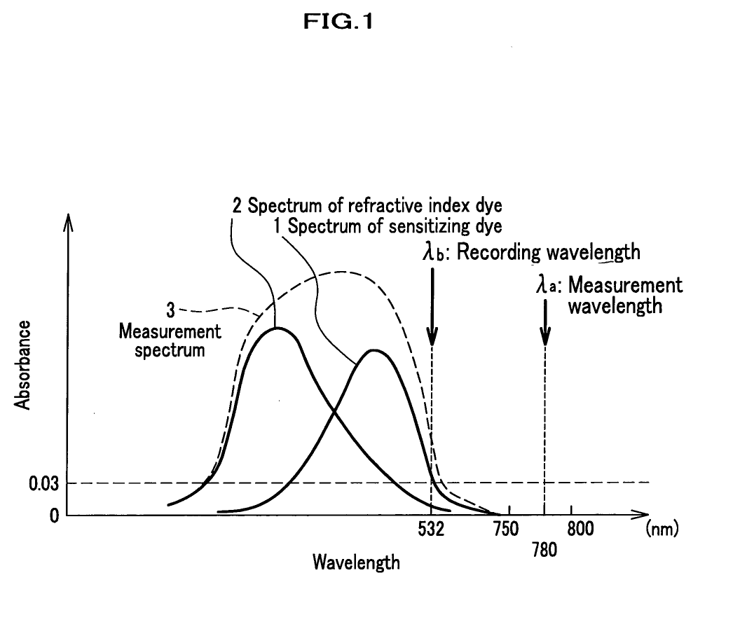

As shown in FIG. 1, which illustrates light absorbance spectrums of the recording layer, a sensitizing dye may be any sensitizing dye without limitation, as long as having absorbance at a recording wavelength λb of the recording light (the reference light) . However, it is desirable that a quantity of the sensitizing dye to be added to the recording layer is increased by using a material having a low light absorbance coefficient ε at the wavelength of the recording light λb for the sensitizing dye. This is because the reaction is proportionate to a density of the sensitizing dye (that is, distances between reactants) . The absorbance in the recording layer is measured at a measurement wavelength λa. The measurement wavelength λa is set to be at an optical wavelength on a long wavelength side, at which the sensitizing dye does not absorb light. An absorbance in the recording layer before recording data at the measurement wavelength λa is set to be 0.030 or less. This absorbance value is not corrected with a thickness of the recording layer, but is given based on a ratio of a quantity of a transmission light to that of an incident light to the recording layer. Thus, even if the thickness of the recording layer is 200 μm or more, the absorbance is kept to be 0.030 or less. Further, if the recording wavelength λb is between 532 and 633 nm, the measurement wavelength λa can be set at the optical wavelength of visible light on the long wavelength side between 750 and 800 nm, for example, at 780 nm at which the sensitizing dye does not absorb the visible light. Proceeding to the next generation of the recording layer, when the recording wavelength λb shifts to the short wavelength side, such as between 400 and 450 nm, and an absorbance spectrum of the sensitizing dye also shifts to the short wavelength side, the measurement wavelength λa can also be shifted to the short wavelength side to be set at the optical wavelength on the long wavelength side between 500 and 800 nm, for example, 650 or 780 nm at which the sensitizing dye does not absorb light.

Specific examples of the sensitizing dye include known organic dyes such as a cyanine-, merocyanine-, phthalocyanine-, azo-, azomethine-, indoaniline-, xanthene-, coumarin-, polymethine-, diallyl ethene-, fulgide fluorane-, anthraquinone- and styryl-based dye. Further, a complex dye may be used as the sensitizing dye.

The polymerization initiator used herein includes a radical generating agent and an acid generating agent.

The binder used herein includes, for example, a copolymer of chlorinated polyethylene, polymethyl methacrylate or methyl methacrylate and other (meta)acrylic alkyl ester; a copolymer of chloroethylene and acrylonitrile; polyvinyl acetate; polyvinyl alcohol; polyvinyl formal; polyvinyl butyral; polyvinyl pyrrolidone; ethyl cellulose; acetyl cellulose; and polycarbonate. The binder preferably has a large difference in a refractive index from a polymer of the polymerizable monomer. However, if the difference between the refractive indexes is too large, compatibility of the binder and the polymerizable monomer is low, so that light may be highly scattered. Thus a binder having a suitable refractive index is required.

The recording layer may contain an agent which is typically used for forming a recording layer for an optical recording medium of this type, such as a sensitizer, an optical brightening agent, an ultraviolet ray absorbing agent, a thermal stabilizer, a chain transfer agent, a plasticizing agent, and a coloring agent, according to the necessity.

Besides the photopolymer material, materials for the recording layer now under study include a refractive index modulation dye type material. In a bright area in an interference pattern, the refractive index modulation dye type material causes a coloring reaction or a decoloring reaction of a refractive index modulation dye contained therein. Meanwhile, in a dark area in the interference pattern, the refractive index modulation dye type material generates a difference of physical property values, such as the refractive index and transmission. As described above, the refractive index modulation dye type material contains a binder, a sensitizing dye, a refractive index modulation dye, and an acid generating agent. Like the photopolymer, when the interference pattern is formed in the recording layer including the refractive index modulation dye type material, the sensitizing dye in the bright area is excited to emit electrons. The emitted electrons travel to the acid generating agent, which thereby generates acids. The generated acids cause the decoloring reaction to decolor the refractive index modulation dye type material, resulting in a change in the refractive index. Alternatively, the generated acids cause the coloring reaction to color the refractive index modulation dye, resulting in a change in the refractive index. In the coloring reaction, the refractive index modulation dye may be called a dye precursor, in particular. The coloring reaction and the decoloring reaction may be caused by a mechanism other than the generation of acids.

As shown in FIG. 1, which illustrates light absorbance spectrums of the recording layer, the recording layer contains the sensitizing dye and a refractive index modulation dye. The sensitizing dye may be any dye without limitation, as long as having absorbance at a recording wavelength λb of a recording light (a reference light) . However, it is desirable that the sensitizing dye used herein has a low light absorbance coefficient ε at the wavelength of the recording light λb to increase a quantity of the sensitizing dye to be added to the recording layer, because absorbance reaction is proportionate to the density of the sensitizing dye. The sensitizing dye which is the same as that contained in the photopolymer material can be used herein.

The absorbance of the recording layer is measured at the measurement wavelength λa. The measurement wavelength λa is set to be at the optical wavelength of visible light on the long wavelength side, at which the sensitizing dye does not absorb visible light. The absorbance of the recording layer before recording data at the measurement wavelength λa is set to be 0.030 or less. This absorbance value is not corrected with the thickness of the recording layer, but is given based on the ratio of a quantity of transmission light to that of incident light to the recording layer. Thus, even if the thickness of the recording layer is 200 μm or more, the absorbance is kept to be 0.030 or less. Further, if the recording wavelength λb is between 532 and 633 nm, the measurement wavelength λa can be set at the optical wavelength of visible light on the long wavelength side between 750 and 800 nm, for example, at 780 nm, at which the sensitizing dye does not absorb the visible light. Proceeding to the next generation of the recording layer, when the recording wavelength λb shifts to the short wavelength side, such as between 400 and 450 nm, and an absorbance spectrum of the sensitizing dye also shifts to the short wavelength side, the measurement wavelength λa can be shifted to the short wavelength side to be set at the optical wavelength on the long wavelength side between 500 and 800 nm, for example, 650 or 780 nm, at which the sensitizing dye does not absorb visible light.

The materials for use in the recording layer under study include silver halide, bichromated gelatin, a photorefractive material, and a photochromic material.

The silver halide is highly sensitive, and has a relatively high resolution. However, it requires complicated wet processing, has a high scattering rate and a low light resistance. Thus there is still large room for improvement when used for a memory.

The bichromated gelatin has a high diffraction efficiency, and a low noise operation characteristic. However, it is poorly sensitive, and has low recording storage stability. Thus there is still room for improvement when used for a memory.

The photorefractive material is rewritable. However, it requires high voltage to be applied thereto for recording data, and has a low recording storage stability. Thus there is still room for improvement when used for a memory.

The photochromic material is also rewritable. However, it is extremely poorly sensitive, and has a low recording storage stability. Thus there is still room for improvement when used for a memory.

Hence, a combination of the materials for the recording layer may be used, such as the silver halide, the bichromated gelatin, the photorefractive material, the photochromic material, the photopolymer material, and the refractive index modulation dye type material. For example, when a refractive index modulation dye type material causing the coloring reaction or the decoloring reaction is combined with a photopolymer material causing the polymerization reaction, an obtained recording layer can easily fix the refractive index modulation dye type material therein, to thereby easily obtain a difference between the two refractive indexes. Thus the material for the recording layer can acquire a synergistic favorable feature. Further, when a photorefractive material is combined with a photopolymer material, an obtained recording layer can easily fix the refractive index modulation dye type material therein, to thereby easily obtain a difference between the two refractive indexes. Thus the material for the recording layer can acquire a synergistic favorable feature. It is to be noted that the material for the recording layer may be a thermal polymerizable resin composition (a thermosetting resin composition) depending on a recording mode to be used.

The optical recording medium may be provided with a light transmission substrate above and below the recording layer so as to hold and protect the same. Thickness of the light transmission substrate may be about 0.05 to 1.2 mm. Materials for the light transmission substrate include an inorganic substance such as glass, and a synthetic resin such as polycarbonate, triacetyl cellulose, cycloolefin polymer, polyethylene terephthalate, polyphenylene sulfide, acrylate resin, methacrylic resin, polystyrene resin, vinyl chloride resin, epoxy resin, polyester resin, and amorphous polyolefin. Of these, glass, polycarbonate and triacetyl cellulose are desirable because of their low double refraction. The light transmission substrate may be made of either the same material or different materials. The light transmission substrate may have an antireflection coating, an oxygen anti-transmission coating, a water anti-transmission coating, and a UV protection coating on a surface thereof according to the necessity.

A holographic memory according to the present invention can be manufactured by a manufacturing method including steps of: preparing a solution in which materials forming the holographic memory are dissolved; filtering the solution; drying the filtered solution to produce a solid substance; crushing the solid substance to produce flakes; and molding the flakes to manufacture a recording layer having a thickness of 200 μm or more. A method of molding the flakes includes pressing the flakes by applying temperature and/or pressure thereto, and melting the flakes into a glass or liquid state to pour the resultant substance into a mold.

In the filtering step, a degree of light scattering can be changed by changing a diameter of a filter used. The scattering can be reduced also by strengthening dispersion (by an increase in a dispersion time, the number of revolutions, and a filling rate of a dispersion medium, or the like). In a medium to be used, the scattering can also be reduced by adding a surfactant or a nonvolatile oil as a dispersion inhibitor thereto, or introducing a group which can improve compatibility into a binder or a dye contained therein. Only one of these techniques may be used, and a combination thereof may also be used, from which a greater effect can be expected.

In a holographic memory according to the embodiment, a bit error rate of a transmission image in an unrecorded medium can be reduced. More specifically, the bit error rate can be reduced to less than 10⁻². A reduced bit error rate of a transmission image in an unrecorded medium can provide a low-noise medium. However, in a holographic memory according to the conventional technology, a method of evaluating light scattering, which correlates with the bit error rate of a transmission image in an unrecorded medium, has not been proposed.

In the present invention, the method of evaluating light scattering of a holographic memory, which correlates with the bit error rate of a transmission image in an unrecorded medium, is established. A wavelength of light affecting the bit error rate, which results in light scattering, is considered to be approximately the same as the recording wavelength λb. In a direct manner, the scattering light can be measured while light at recording wavelength λb is irradiated to the recording layer. However, the scattering light can not be evaluated accurately in this manner, because the sensitizing dye and the refractive index modulation dye type material absorb light at the recording wavelength λb. In the embodiment, a wavelength at which the sensitizing dye and the refractive index modulation dye type material do not absorb light is selected as the measurement wavelength λa. When the light at measurement wavelength λa is applied to the recording layer, the light is not absorbed by the dye. Thus, a result of subtracting the reflected light and transmitted light from the incident light is considered as the scattering light. It is therefore believed that there is a correlation that the larger the absorbance at the measurement wavelength λa is, the more the scattering becomes. Thus, a degree of the scattering can be evaluated quantitatively by measuring the absorbance of the measurement wavelength λa.

The method of evaluating the scattering can demonstrate a relation between the absorbance at the measurement wavelength λa correlating with the degree of the scattering and the bit error rate of a transmission image in an unrecorded medium. A bit error rate of a transmission image in an unrecorded medium for a plurality of samples was measured, and it was found that the bit error rate of the transmission image in an unrecorded medium can be less than 10⁻², if the absorbance at the measurement wavelength λa is set to be 0.030 or less.

According to the embodiment, a holographic memory capable of keeping a bit error rate of a transmission image in an unrecorded medium low can be provided, even when the recording layer is made thicker. Further, a method of manufacturing a recording layer capable of reducing a bit error rate of a transmission image in an unrecorded medium to 0.030 or less is established, which was found in the course of measuring the absorbance and the bit error rate of a transmission image in an unrecorded medium for the plurality of samples. In the embodiment, the optical recording medium for recording light information using holography (interference) is described. However, the present invention is not limited to this embodiment, and a multilayered optical memory can be applied thereto.

### EXAMPLES

Next is described more specifically the optical recording medium of the present invention according to examples, however, the present invention is not limited to the examples.

### <Manufacturing Optical Recording Medium>

An optical recording medium was manufactured using a refractive index modulation dye type material. First, a solution was prepared. To make a recording layer of the optical recording medium, materials shown in Table 1 were weighed to have respective mass ratios thereof also shown in Table 1, including a binder, a dye which is decolored by adding acids, an acid generating agent, a sensitizing dye, and a methylene chloride and an acetonitrile as solvents. The materials were weighed under a red light lamp. An anti-scattering agent may be added to the materials in order to improve dispersion and compatibility thereamong. The anti-scattering agent may be any surfactant having an OH group and an alkyl group at a terminal thereof.

TABLE 1

| | Material | Mass Ratio |
|---|---|---|
| Binder | PMMA | 1000 |
| Dye to be decolored | Dye 1 | 100 |
| by acids | | |
| Acid generating | Acid generating | 500 |
| agent | agent | |
| Sensitizing dye | Dye 2 | 8 |
| Solvent | methylene chloride | 3250 |
| Solvent | acetonitrile | 1052.5 |

The PMMA in Table 1 is a copolymer of PMMA-EA: polymethyl methacrylate and ethyl acrylate (produced by Aldrich Corp, Mw: 101000). The dye 1 is a dissociative dye expressed by Formula 1.

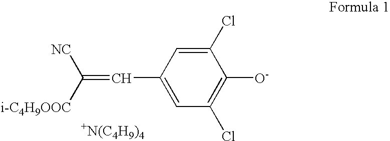

The acid generating agent is a diphenyliodonium hexafluorophosphoric acid (Cas No. 58109-40-3). The dye 2 is a cyanine dye expressed by Formula 2:

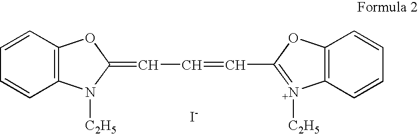

All of the materials were put in a brown eggplant-shaped flask and mixed under a red light lamp, and stirred for three hours by a stirrer to obtain a mixed solution. The solution was divided into four equal portions. One portion is used for manufacturing a recording layer for Sample 1 for Example 1, two portions for Sample 2 and Sample 3 both for Example 2, and the other for Sample 4 for Comparative Example 1.

The solutions were filtrated next. The solution for Example 1 was filtrated with a filter about 500 nm in diameter. The solutions for Example 2 and Example 3 were filtrated with a filter about 100 nm in diameter. The solution for Comparative Example 1 was not filtrated. In all manufacturing steps, an only difference between Example 1, Example 2 and Example 3, and Comparative Example 1 was this point of whether filtrated or not.

Then a recording layer was molded. The solutions for Example 1, Example 2, Example 3, and Comparative Example 1 were left to be dried at 40 degrees Celsius for 24 hours. At this time, a weight percentage of each of the four solutions to a residual solvent thereof was reduced to 5 weight % or less. This resulted in a higher viscosity of each of the four solutions, which made it easy to form a layer having a thickness of 200 μm or more. The four solutions each with some quantity of the residual solvent left therein were vacuum dried at 40 degrees Celsius, and were solidified to produce respective solid substances. The respective solid substances were crushed into flakes. The crushed solid substances were each placed on a glass substrate as a light transmission substrate. Further, a spacer having the same thickness and an opening with the same shape as that of the desired recording layer is also placed on the glass substrate. The thickness of the spacer for Example 1, Example 2 and Comparative Example 1 was each 250 μm, and, for Example 3, 500 μm. After that, the solid substances each on the glass substrate were heated to 120 degrees Celsius and pressed for three minutes. The pressing fused each of the flaky solid substances into one piece to mold a recording layer on the glass substrate. To change a thickness of the recording layer, the thickness of a spacer can be changed, and a quantity of flakes can be increased or decreased according to the thickness. As described above, the optical recording media for Example 1, Example 2, Example 3, and Comparative Example 1 were obtained.

For molding a recording layer, each of the solutions for Example 1 and Comparative Example 1 may be applied to a light transmission substrate using, for example, a coater having a clearance (a gap length) of 300 μm. Each of the solutions may be dried and then applied thereto repeatedly to form a thicker recording layer.

### <Measurement of Thickness of Recording Layer>

Thickness of the recording layer of the optical recording media for Example 1, Example 2, Example 3 and Comparative Example 1 was measured using a DIGITAL MICROMETER manufactured by Sony Corp. The thickness of each recording layer was calculated by subtracting a thickness of the glass substrate measured in advance from that of the entire optical recording medium measured herein. The measured thickness of each recording layer is shown in Table 2. The thickness of each recording layer for Example 1, Example 2 and Comparative Example 1 was all 250 μm, and for Example 3, 500 μm.

TABLE 2

| | | | Comparative |
|---|---|---|---|
| Example 1 | Example 2 | Example 3 | Example 1 |
| Sample No. | | | |
| 1 | 2 | 3 | 4 |

| | | | | |
|---|---|---|---|---|
| Filter diameter | 100 nm | 100 nm | 100 nm | |
| for filtrating | | | | |
| (nm) | | | | |
| Absorbance at a | 0.027 | 0.014 | 0.028 | 0.04 |
| wavelength of | | | | |
| 780 nm | | | | |
| Thickness of | 250 | 250 | 500 | 250 |
| recording layer | | | | |
| BER after | 6.2E−4 | 4.0E−4 | 7.8E−4 | 3.0E−2 |
| transmittance | | | | |

### <Measurement of Absorbance of Optical Recording Medium>

An absorbance of each of the optical recording media for Example 1, Example 2, Example 3, and Comparative Example 1 at a wavelength of 780 μm was measured. The absorbance of each recording layer was calculated by subtracting an absorbance of two glass substrates from that of an entire sample medium with a recording layer interposed between the two glass substrates. The measured absorbance of each recording layer is shown in Table 2, namely, 0.027, 0.014, 0.028 and 0.04 for Example 1, Example 2, Example 3, and Comparative Example 1, respectively. The absorbance of each recording layer for Example 1 and Example 2 is smaller than that for Comparative Example 1. Considering that the thickness of each recording layer for Example 1, Example 2 and Comparative Example 1 is all the same, scattering in each recording layer for Example 1 and Example 2 is believed to be smaller than that for Comparative Example 1. This may be because that filtrating contributed to eliminating cause of the scattering. Further, scattering in the recording layer for Example 2 is believed to be smaller than that for Example 1. This may be because that filtrating with a filter 100 nm in diameter in Example 2 contributed to further eliminating cause of the scattering, as compared to that with a filter 500 nm in diameter in Example 1.

### <Measurement of Bit Error Rate of Transmission Image in Unrecorded Medium>

Each bit error rate of a transmission image in an unrecorded sample for Example 1, Example 2, Example 3, and Comparative Example 1 was measured. Data created with a spatial light modulation (SLM) was transmitted through each optical recording medium for Example 1, Example 2, Example 3 and Comparative Example 1, using a laser at a wavelength of 532 nm, and was read out by a charge coupled device (CCD) . The bit error rate of a transmission image in an unrecorded sample was computed based on whether or not the read out data is identical with the created data. The computed bit error rate of the transmission image in the unrecorded sample is shown in Table 2, which was 6.2×10⁻⁴, 4.0×10⁻⁴, 7.8×10⁻⁴ and 3.0×10⁻², for Example 1, Example 2, Example 3 and Comparative Example 1, respectively. Each bit error rate of Example 1 and Example 2 was smaller than that of Comparative Example 1. This observation coincided with the result of absorbance measurement that the scattering in each recording layer for Example 1 and Example 2 was smaller than that for Comparative Example 1. Thus the measurement of absorbance enabled to regard the scattering as cause of raising the bit error rate of a transmission image in an unrecorded medium. It was also demonstrated that the filtrating contributed to eliminating cause of the scattering to thereby lower a bit error rate of a transmission image in an unrecorded medium. It was also contemplated that filtrating with a filter 100 nm in diameter in Example 2 contributed to further eliminating cause of the scattering, as compared to that with a filter 500 nm in diameter in Example 1 to thereby lower the bit error rate of a transmission image in an unrecorded medium even further. The result obtained from Example 3 also demonstrated that the bit error rate of a transmission image in an unrecorded medium was excellent, if the absorbance was 0.030 or less, even when the thickness of the recording layer became thicker.

The embodiments according to the present invention have been explained as aforementioned. However, the embodiments of the present invention are not limited to those explanations, and those skilled in the art ascertain the essential characteristics of the present invention and can make the various modifications and variations to the present invention to adapt it to various usages and conditions without departing from the spirit and scope of the claims.

1. An optical recording medium comprising: a recording layer having a thickness of 200 μm or more, containing at least one kind of a dye, and capable of recording data in three dimensions,
wherein an absorbance of the recording layer is 0.030 or less before the data is recorded at a wavelength longer than a wavelength of the recording light, at which the dye does not absorb light.

2. The optical recording medium according to claim 1, wherein the wavelength longer than the wavelength of the recording light is 750 nm to 800 nm.

3. The optical recording medium according to claim 1, wherein the dye comprises a sensitizing dye and a refractive index modulation dye, and the refractive index modulation dye shows a coloring reaction or a decoloring reaction when the data is recorded.

4. The optical recording medium according to claim 1, wherein the recording layer comprises a binder and a polymerizable monomer, and in the polymerizable monomer, a polymerization reaction occurs, when the data is recorded or is fixed in the recording layer.

5. A method of manufacturing an optical recording medium, comprising the steps of:
preparing a solution in which materials forming a recording layer for recording a plurality of pieces of data in a thickness direction thereof are dissolved in a solvent;
filtering the solution;
drying the filtered solution to produce a solid substance;
crushing the solid substance to produce flakes; and
molding the flakes to form the recording layer having a thickness of 200 μm or more.

6. The optical recording medium according to claim 2, wherein the wavelength longer than the wavelength of the recording light is 780 nm.
